(19) United States
(12) Patent Application Publication
(10) Pub. No.: US 2025/0183655 A1
(43) Pub. Date: Jun. 5, 2025

(54) RAPID REACTION PTC CIRCUIT PROTECTION DEVICE

(71) Applicant: Littelfuse, Inc., Chicago, IL (US)

(72) Inventors: Yu Tian, Shanghai (CN); ChiHao Ku, New Taipei City (TW); Bing Wang, Shanghai (CN); Nina Liu, Shanghai (CN)

(73) Assignee: Littelfuse, Inc., Chicago, IL (US)

(21) Appl. No.: 18/954,952

(22) Filed: Nov. 21, 2024

(30) Foreign Application Priority Data
Nov. 30, 2023 (CN) 2023116227300

(51) Int. Cl. H02H 9/02; H01C 1/14; H01C 7/02

(52) U.S. Cl. CPC H02H 9/026; H01C 1/1406; H01C 7/021; H01C 7/028

(57) ABSTRACT

A positive temperature coefficient (PTC) circuit protection device including a dielectric substrate layer, first and second high resistance layers disposed on a top surface of the substrate layer in a spaced apart relationship to define a gap therebetween, a PTC layer disposed on the top surface of the substrate layer in the gap and in contact with the first and second high resistance layers, a mask layer covering a top surface of the PTC layer and portions of top surfaces of the first and second high resistance layers, an electrically conductive first terminal covering a first longitudinal end of the substrate layer and an outermost end of the first high resistance layer distal from the PTC layer, and an electrically conductive second terminal covering a second longitudinal end of the substrate layer and an outermost end of the second high resistance layer distal from the PTC layer.

### BACKGROUND

### Cross-Reference to Corresponding Applications

This application claims the benefit of priority to, Chinese Patent Application No. 2022112610991, filed Nov. 30, 2023, entitled “RAPID REACTION PTC CIRCUIT PROTECTION DEVICE,” which application is incorporated herein by reference in its entirety.

### FIELD

The present disclosure relates generally to the field of circuit protection devices. More specifically, the present disclosure relates to a circuit protection device that includes a positive temperature coefficient element and that is configured to react rapidly to an overcurrent condition.

### DESCRIPTION OF RELATED ART

Fuses are commonly used as circuit protection devices and are typically installed between a source of electrical power and a component in an electrical circuit that is to be protected. A conventional fuse includes a fusible element disposed within a hollow, electrically insulating fuse body. Upon the occurrence of a fault condition, such as an overcurrent condition, the fusible element melts or otherwise separates to interrupt the flow of electrical current through the fuse.

When the fusible element of a fuse separates as a result of an overcurrent condition, it is sometimes possible for an electrical arc to propagate through the air between the separated portions of the fusible element (e.g., through vaporized particulate of the melted fusible element). If not extinguished, this electrical arc may allow significant follow-on currents to flow to from a source of electrical power to a protected component in a circuit, resulting in damage to the protected component despite the physical opening of the fusible element.

One solution that has been implemented to eliminate electrical arcing in fuses is to replace the fusible element of a fuse with a positive temperature coefficient (PTC) element. A PTC element is formed of a PTC material composed of electrically conductive particles suspended in a non-conductive medium (e.g., a polymer). PTC materials exhibit a relatively low electrical resistance within a normal operating temperature range. However, when the temperature of a PTC material exceeds the normal operating temperature range and reaches a “trip temperature,” such as may result from excessive current flowing through the PTC material, the resistance of the PTC material increases sharply. This increase in resistance mitigates or arrests the flow of current through the PTC element. Subsequently, when the PTC material cools (e.g., when the overcurrent condition subsides), the resistance of the PTC material decreases, and the PTC element becomes conductive again. The PTC element thus acts as a resettable fuse. Since the PTC element does not physically open in the manner of a fusible element, there is no opportunity for an electrical arc to form or propagate.

The time it takes for a PTC element to heat up and reach its trip temperature in response to an overcurrent condition is commonly referred to as “time to trip.” The time to trip for a conventional PTC circuit protection device is typically on the order of several seconds. However, there is growing demand for PTC circuit protection devices having a much faster time to trip, such as on the order of tens or hundreds of milliseconds. It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A positive temperature coefficient (PTC) circuit protection device according to an embodiment of the present disclosure may include a dielectric substrate layer, first and second high resistance layers disposed on a top surface of the substrate layer in a spaced apart relationship to define a gap therebetween, a PTC layer disposed on the top surface of the substrate layer in the gap and in contact with the first and second high resistance layers, a mask layer covering a top surface of the PTC layer and portions of top surfaces of the first and second high resistance layers, an electrically conductive first terminal covering a first longitudinal end of the substrate layer and an outermost end of the first high resistance layer distal from the PTC layer, and an electrically conductive second terminal covering a second longitudinal end of the substrate layer and an outermost end of the second high resistance layer distal from the PTC layer.

A PTC circuit protection device according to another embodiment of the present disclosure may include a dielectric substrate layer, a PTC layer disposed on a top surface of the substrate layer, first and second high resistance layers disposed on a top surface of the PTC layer in a spaced apart relationship to define a gap therebetween, the PTC layer having an effective portion located directly below the gap, a mask layer covering top surfaces of the first and second high resistance layers and covering the PTC layer in the gap, an electrically conductive first terminal covering a first longitudinal end of the substrate layer and an outermost end of the first high resistance layer distal from the PTC layer, and an electrically conductive second terminal covering a second longitudinal end of the substrate layer and an outermost end of the second high resistance layer distal from the PTC layer.

A PTC circuit protection device according to another embodiment of the present disclosure may include a dielectric substrate layer having a first hole and a second hole formed therethrough, first and second high resistance layers disposed on a top surface of the substrate layer in a spaced apart relationship to define a gap therebetween, wherein the first high resistance layer has a first contact portion extending into the first hole and the second high resistance layer has a second contact portion extending into the second hole, a PTC layer disposed on the top of the first and second high resistance layers and having an effective portion extending into the gap, a mask layer covering a top surface of the PTC layer, an electrically conductive first terminal disposed on a bottom surface of the substrate layer and in contact with the first contact portion of the first high resistance layer, and an electrically conductive second terminal disposed on the bottom surface of the substrate layer and in contact with the second contact portion of the second high resistance layer.

### BRIEF DESCRIPTION OF THE DRAWINGS

FIG. 1A is a perspective view illustrating a circuit protection device in accordance with an exemplary embodiment of the present disclosure;

FIG. 1B is an exploded view illustrating the circuit protection device shown in FIG. 1A;

FIG. 2A is a perspective view illustrating a circuit protection device in accordance with another exemplary embodiment of the present disclosure;

FIG. 2B is an exploded view illustrating the circuit protection device shown in FIG. 2A;

FIG. 3A is a perspective view illustrating a circuit protection device in accordance with another exemplary embodiment of the present disclosure;

FIG. 3B is an cross-sectional view illustrating the circuit protection device shown in FIG. 3A.

FIG. 3C is an exploded view illustrating the circuit protection device shown in FIG. 2A.

### DETAILED DESCRIPTION

An exemplary embodiment of a circuit protection device in accordance with the present disclosure will now be described more fully hereinafter with reference to the accompanying drawings. The circuit protection device may, however, be embodied in many different forms and should not be construed as being limited to the embodiments set forth herein. Rather, these embodiments are provided so that this disclosure will convey certain exemplary aspects of the circuit protection device to those skilled in the art.

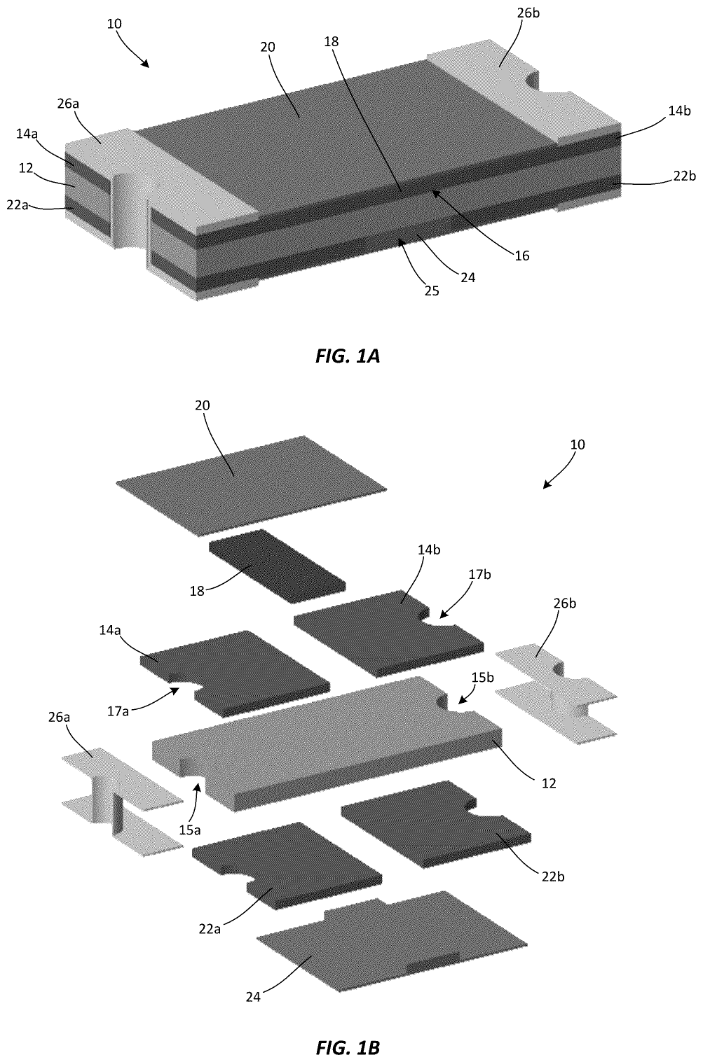

Referring to FIGS. 1A and 1B, a perspective view and an exploded view illustrating a positive temperature coefficient (PTC) circuit protection device 10 (hereinafter “the device 10”) in accordance with an exemplary embodiment of the present disclosure are shown. For the sake of convenience and clarity, terms such as “front,” “rear,” “top,” “bottom,” “up,” “down,” “above,” “below,” “lateral,” “longitudinal,” etc. may be used herein to describe the relative placement and orientation of various components of the device 10, each with respect to the geometry and orientation of the device 10 as it appears in FIGS. 1A and 1B. Said terminology will include the words specifically mentioned, derivatives thereof, and words of similar import.

The device 10 may include a planar substrate layer 12 having first and second high resistance layers 14a, 14b disposed on a top surface thereof in a longitudinally spaced apart arrangement to define a gap 16 therebetween. As best shown in FIG. 1A, the outermost longitudinal edges of the first and second high resistance layers 14a, 14b may be flush with respective longitudinal edges of the substrate layer 12. The present disclosure is not limited in this regard.

The substrate layer 12 may be formed of a dielectric material such as FR-4, ceramic, or the like. The first and second high resistance layers 14a, 14b may be formed of a high resistance, electrically conductive material. In a non-limiting example, the first and second high resistance layers 14a, 14b may be metal foils formed of nickel-phosphorus plated with copper. In another non-limiting example, the first and second high resistance layers 14a, 14b may be metal foils formed of nickel-chromium alloy. More generally, the first and second high resistance layers 14a, 14b may be formed of a material having an electrical resistivity in a range of 10⁰ Ohm/to 10³ Ohm/.

In various embody embodiments, the substrate layer 12 and the first and second high resistance layers 14a, 14b may have castellations 15a, 15b and 17a, 17b formed in the outermost longitudinal ends thereof, respectively. The present disclosure is not limited in this regard.

The device 10 may further include a PTC layer or plaque 18 (hereinafter “the PTC layer 18”) disposed on the substrate layer 12 in the gap 16, in contact with the first and second high resistance layers 14a, 14b. The PTC layer 18 may be formed of any type of PTC material composed of electrically conductive particles suspended in a non-conductive medium (e.g., polymeric PTC material, ceramic PTC material, etc.) and formulated to have an electrical resistance that increases as the temperature of the PTC element 18 increases. Particularly, the PTC layer 18 may have a predetermined “trip temperature” above which the electrical resistance of the PTC layer 18 rapidly and drastically increases (e.g., in a nonlinear fashion) in order to substantially arrest electrical current passing therethrough. In a non-limiting, exemplary embodiment of the device 10, the PTC layer 18 may have a trip temperature in a range of 50 degrees Celsius to 220 degrees Celsius. In various embodiments, the PTC layer 18 may be applied to the substrate layer 12 in a solid or liquid state during manufacture of the device 10. The present disclosure is not limited in this regard.

The device 10 may further include a mask layer 20 disposed atop the PTC layer 18 and the first and second high resistance layers 14a, 14b. In various embodiments, the mask layer 20 may be formed of epoxy. The present disclosure is not limited in this regard. As best shown in FIG. 1A, the outermost longitudinal edges of the mask layer 20 may entirely cover the PTC layer 18 but may extend longitudinally short of the outermost longitudinal edges of the first and second high resistance layers 14a, 14b, thus leaving portions of the top surfaces of the first and second high resistance layers 14a, 14b exposed for terminal plating as further described below.

The device 10 may further include third and fourth high resistance layers 22a, 22b and a mask layer 24 disposed on an underside of the substrate layer 12 that substantially mirror the first and second high resistance layers 14a, 14b and the mask layer 20 on the top side of the substrate layer 12, expect that the mask layer 20 fills a gap 25 between the third and fourth high resistance layers 22a, 22b since there is no PTC layer on the underside of the substrate layer 12. The third and fourth high resistance layers 22a, 22b and the mask layer 24 are provided to facilitate process uniformity during manufacture of the device 10, and in various embodiments may be omitted from the device 10 without departing from the scope of the present disclosure.

The device 10 may further include electrically conductive first and second terminals 26a, 26b formed on longitudinal ends thereof for facilitating electrical connection of the device 10 within a circuit (e.g., surface mounting the device 10 on a circuit board). The first terminal 26a may cover the exposed portion of the top surface of the first high resistance layer 14a, the castellated portions of the corresponding longitudinal edges of the first high resistance layer 14a, substrate layer 12, and third high resistance layer 22a, and the exposed portion of the bottom surface of the third high resistance layer 22a. Similarly, the second terminal 26b may cover the exposed portion of the top surface of the second high resistance layer 14b, the castellated portions of the corresponding longitudinal edges of the second high resistance layer 14b, substrate layer 12, and fourth high resistance layer 22b, and the exposed portion of the bottom surface of the fourth high resistance layer 22b.

During normal operation, the device 10 may be connected in a circuit between a source of electrical power and a load (e.g., via solder connection of the first and second terminals 26a, 26b to corresponding terminals on a circuit board), and current may flow through the device 10 from the first terminal 26a, to the first high resistive layer 14a, to the PTC layer 18, to the second high resistive layer 14b, to the second terminal 26b, or vice versa.

Upon the occurrence of an overcurrent condition, wherein current flowing through the device 10 causes the PTC element 18 to reach a temperature within its normal trip temperature range, the resistance of the PTC element 18 may rapidly increase and substantially arrest current flowing therethrough, thus protecting connected circuit components from damage that could otherwise result from the overcurrent condition. Once the overcurrent condition subsides and the PTC element 18 cools to a temperature below its normal trip temperature range, the PTC element 18 may become electrically conductive again and the device 10 may resume normal operation.

Advantageously, the quantity of PTC material in the PTC layer 18 of the device 10 is significantly less than the quantity of PTC material used in conventional PTC circuit protection devices of similar size. For example, the quantity of PTC material in the PTC layer 18 may be in a range of 0.1 milligrams to 1 milligram, or about 10% or less of the quantity of PTC material used in conventional PTC circuit protection devices of similar size. Thus, the thermal mass of the PTC layer 18 is greatly reduced relative to conventional PTC circuit protection devices, resulting in a significantly faster time to trip relative to conventional PTC circuit protection devices of similar size. For example, the device 10 may have a time to trip in a range of 10⁻¹ milliseconds to 10³ milliseconds. The present disclosure is not limited in this regard. Additionally, owing to the first and second high resistance layers 14a, 14b, the device 10 may exhibit relatively high electrical resistance, similar to conventional PTC circuit protection devices of similar size, even though the quantity of PTC material has been reduced. Moreover, the electrical resistance of the device 10 can be easily tailored/modified by changing the geometry (e.g., the width and/or thickness) of the first and second high resistance layers 14a, 14b. Still further, during an overcurrent condition in the device 10, the first and second high resistance layers 14a, 14b may act as heaters that expediate heating of the PTC layer 18, further reducing the time to trip of the device 10.

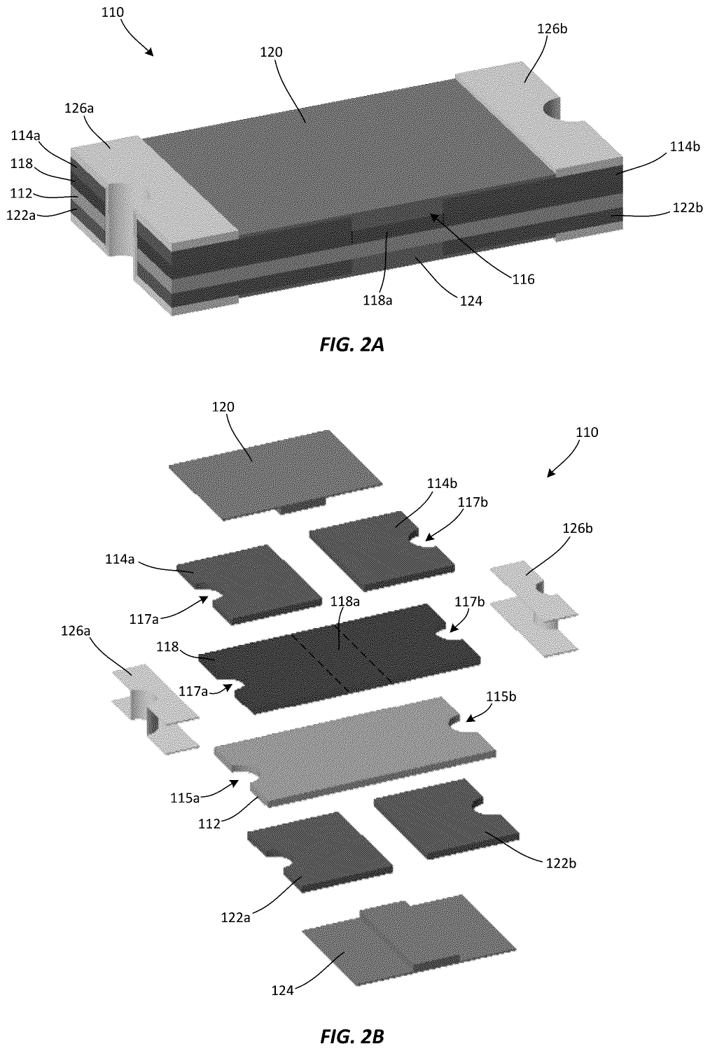

Referring to FIGS. 2A and 2B, a perspective view and an exploded view illustrating another PTC circuit protection device 110 (hereinafter “the device 110”) in accordance with an exemplary embodiment of the present disclosure are shown. For the sake of convenience and clarity, terms such as “front,” “rear,” “top,” “bottom,” “up,” “down,” “above,” “below,” “lateral,” “longitudinal,” etc. may be used herein to describe the relative placement and orientation of various components of the device 110, each with respect to the geometry and orientation of the device 110 as it appears in FIGS. 2A and 2B. Said terminology will include the words specifically mentioned, derivatives thereof, and words of similar import.

The device 110 may include a planar substrate layer 112, a planar PTC layer 118 having an central effective portion 118a (described in greater detail below) disposed atop the substrate layer 112, and first and second high resistance layers 114a, 114b disposed atop the PTC layer 118 in a longitudinally spaced apart arrangement to define a gap 116 therebetween, wherein the effective portion 118a of the PTC layer 118 is located directly below the gap 116. As best shown in FIG. 2A, the substrate layer 112 and the PTC layer 118 may have substantially the same length and width, and the outermost longitudinal edges of the of the first and second high resistance layers 114a, 114b may be flush with respective longitudinal edges of the substrate layer 12 and the PTC layer 118. The present disclosure is not limited in this regard.

The substrate layer 112 may be formed of a dielectric material such as FR-4, ceramic, or the like. The PTC layer 118 may be formed of any type of PTC material (e.g., polymeric PTC material, ceramic PTC material, etc.) formulated to have an electrical resistance that increases as the temperature of the PTC element 118 increases. Particularly, the PTC layer 118 may have a predetermined “trip temperature” above which the electrical resistance of the PTC layer 118 rapidly and drastically increases (e.g., in a nonlinear fashion) in order to substantially arrest electrical current passing therethrough. In a non-limiting, exemplary embodiment of the device 110, the PTC layer 118 may have a trip temperature in a range of 50 degrees Celsius to 220 degrees Celsius. In various embodiments, the PTC layer 18 may be applied to the substrate layer 12 in a solid or liquid state during manufacture of the device 10. The present disclosure is not limited in this regard.

The first and second high resistance layers 114a, 114b may be formed of a high resistance, electrically conductive material. In a non-limiting example, the first and second high resistance layers 114a, 114b may be metal foils formed of nickel-phosphorus plated with copper. In another non-limiting example, the first and second high resistance layers 114a, 114b may be metal foils formed of nickel-chromium alloy. More generally, the first and second high resistance layers 114a, 114b may be formed of a material having a surface resistivity in a range of 10⁰ Ohm/to 10³ Ohm/.

In various embodiments, the substrate layer 112, the PTC layer 118, and the first and second high resistance layers 114a, 14b may have castellations 115a, 115b, 117a, 117b, and 119a, 119b formed in the outermost longitudinal ends thereof, respectively. The present disclosure is not limited in this regard.

The device 110 may further include a mask layer 120 disposed atop the first and second high resistance layers 114a, 114b and within the gap 116. In various embodiments, the mask layer 120 may be formed of epoxy. The present disclosure is not limited in this regard. As best shown in FIG. 2A, the outermost longitudinal edges of the mask layer 120 may extend longitudinally short of the outermost longitudinal edges of the first and second high resistance layers 114a, 114b, thus leaving portions of the top surfaces of the first and second high resistance layers 114a, 114b exposed for terminal plating as further described below.

The device 110 may further include third and fourth high resistance layers 122a, 122b and a mask layer 124 disposed on an underside of the substrate layer 112 that substantially mirror the first and second high resistance layers 114a, 114b and the mask layer 120 on the top of the PTC layer 112. The third and fourth high resistance layers 122a, 122b and the mask layer 124 are provided to facilitate process uniformity during manufacture of the device 110, and in various embodiments may be omitted from the device 110 without departing from the scope of the present disclosure.

The device 110 may further include electrically conductive first and second terminals 126a, 126b formed on longitudinal ends thereof for facilitating electrical connection of the device 110 within a circuit (e.g., surface mounting the device 110 on a circuit board). The first terminal 126a may cover the exposed portion of the top surface of the first high resistance layer 114a, the castellated portions of the corresponding longitudinal edges of the first high resistance layer 114a, PTC layer 118, substrate layer 112, and third high resistance layer 122a, and the exposed portion of the bottom surface of the third high resistance layer 122a. Similarly, the second terminal 126b may cover the exposed portion of the top surface of the second high resistance layer 114b, the castellated portions of the corresponding longitudinal edges of the second high resistance layer 114b, PTC layer 118, substrate layer 112, and fourth high resistance layer 122b, and the exposed portion of the bottom surface of the fourth high resistance layer 122b.

During normal operation, the device 110 may be connected in a circuit between a source of electrical power and a load (e.g., via solder connection of the first and second terminals 126a, 126b to corresponding terminals on a circuit board), and current may flow through the device 110 from the first terminal 126a, to the first high resistive layer 114a, to the effective portion 118a of the PTC layer 118, to the second high resistive layer 114b, to the second terminal 126b, or vice versa. Since the PTC layer 118 exhibits much greater electrical resistance than the first and second high resistance layers 114a, 114b (i.e., even when the PTC layer 118 is in a normal, un-tripped state), current will flow through the first and second high resistance layers 114a, 114b and will not short directly through the PTC layer 118. That is, current will not flow through the PTC layer 118 other than through the effective portion 118a bridging the first and second high resistive layers 114a, 114b.

Upon the occurrence of an overcurrent condition, wherein current flowing through the device 110 causes the PTC element 118 to reach a temperature within its normal trip temperature range, the resistance of the PTC element 118 may rapidly increase and substantially arrest current flowing therethrough, thus protecting connected circuit components from damage that could otherwise result from the overcurrent condition. Once the overcurrent condition subsides and the PTC element 118 cools to a temperature below its normal trip temperature range, the PTC element 118 may become electrically conductive again and the device 110 may resume normal operation.

Advantageously, the quantity of PTC material in the effective portion 118a of the PTC layer 118 of the device 110 is significantly less than the quantity of PTC material used in conventional PTC circuit protection devices of similar size. For example, the quantity of PTC material in the effective portion 118a may be in a range of 0.1 milligrams to 1 milligram, or about 10% or less of the quantity of PTC material used in conventional PTC circuit protection devices of similar size. Thus, the thermal mass of the effective portion 118a of the PTC layer 118 is greatly reduced relative to conventional PTC circuit protection devices, resulting in a significantly faster time to trip relative to conventional PTC circuit protection devices of similar size. For example, the device 110 may have a time to trip in a range of 10⁻¹ milliseconds to 10³ milliseconds. The present disclosure is not limited in this regard. Additionally, owing to the first and second high resistance layers 114a, 114b, the device 10 may exhibit relatively high electrical resistance, similar to conventional PTC circuit protection devices of similar size, even though the quantity of PTC material has been reduced. Moreover, the electrical resistance of the device 110 can be easily tailored/modified by changing the geometry (e.g., the width and/or thickness) of the first and second high resistance layers 114a, 114b. Still further, during an overcurrent condition in the device 110, the first and second high resistance layers 114a, 114b may act as heaters that expediate heating of the effective portion 118a of the PTC layer 118, further reducing the time to trip of the device 110.

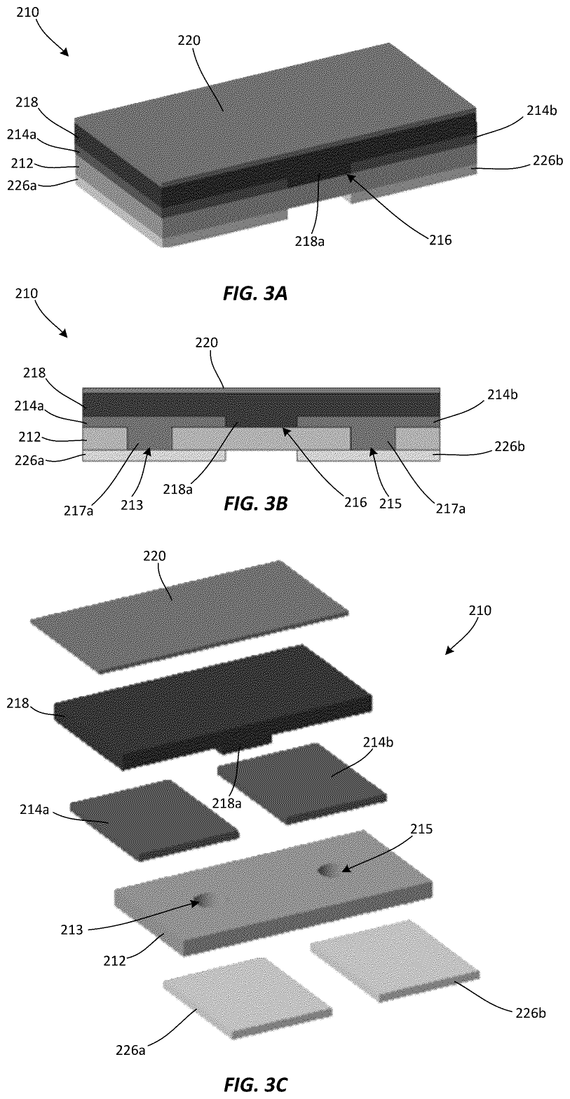

Referring to FIGS. 3A-3C, a perspective view, a cross-sectional view, and an exploded view illustrating another PTC circuit protection device 210 (hereinafter “the device 210”) in accordance with an exemplary embodiment of the present disclosure are shown. For the sake of convenience and clarity, terms such as “front,” “rear,” “top,” “bottom,” “up,” “down,” “above,” “below,” “lateral,” “longitudinal,” etc. may be used herein to describe the relative placement and orientation of various components of the device 210, each with respect to the geometry and orientation of the device 210 as it appears in FIGS. 3A-3C. Said terminology will include the words specifically mentioned, derivatives thereof, and words of similar import.

The device 210 may include a planar substrate layer 212 having first and second holes or vias 213, 215 formed therethrough, wherein the first and second holes 213, 215 are spaced apart from one another along a length of the substrate layer 212. The device may further include first and second high resistance layers 214a, 214b disposed on a top surface of the substrate layer 212 in a longitudinally spaced apart arrangement to define a gap 216 therebetween. The first and second high resistance layers 214a, 214b may include respective first and second contact portions 217a, 217b that extend into the first and second holes 213, 215 in the substrate layer 212, respectively.

The device 210 may further include a PTC layer 218 disposed atop the first and second high resistance layers 214a, 214b and having a central effective portion 218a (described in greater detail below) that extends into the gap 216. As best shown in FIGS. 3A and 3B, the substrate layer 212 and the PTC layer 218 may have substantially the same length and width, and the outermost longitudinal edges of the of the first and second high resistance layers 214a, 214b may be flush with respective longitudinal edges of the substrate layer 212 and the PTC layer 218. The present disclosure is not limited in this regard.

The substrate layer 212 may be formed of a dielectric material such as FR-4, ceramic, or the like. The PTC layer 218 may be formed of any type of PTC material (e.g., polymeric PTC material, ceramic PTC material, etc.) formulated to have an electrical resistance that increases as the temperature of the PTC element 218 increases. Particularly, the PTC layer 218 may have a predetermined “trip temperature” above which the electrical resistance of the PTC layer 218 rapidly and drastically increases (e.g., in a nonlinear fashion) in order to substantially arrest electrical current passing therethrough. In a non-limiting, exemplary embodiment of the device 210, the PTC layer 218 may have a trip temperature in a range of 50 degrees Celsius to 220 degrees Celsius. In various embodiments, the PTC layer 218 may be applied to the substrate layer 112 in a solid or liquid state during manufacture of the device 110. The present disclosure is not limited in this regard.

The first and second high resistance layers 214a, 214b may be formed of a high resistance, electrically conductive material. In a non-limiting example, the first and second high resistance layers 214a, 214b may be metal foils formed of nickel-phosphorus plated with copper. In another non-limiting example, the first and second high resistance layers 214a, 214b may be metal foils formed of nickel-chromium alloy. More generally, the first and second high resistance layers 214a, 214b may be formed of a material having a surface resistivity in a range of 10⁰ Ohm/to 10³ Ohm/.

The device 210 may further include a mask layer 220 disposed atop the PTC layer 218. In various embodiments, the mask layer 20 may be formed of epoxy. As best shown in FIG. 3A, the mask layer 220 may have substantially the same length and width as the PTC layer 218 and may entirely cover the PTC layer 218. The present disclosure is not limited in this regard.

The device 210 may further include electrically conductive first and second terminals 226a, 226b disposed on a bottom surface of the substrate layer 212 in a longitudinally spaced-apart arrangement for facilitating electrical connection of the device 210 within a circuit (e.g., surface mounting the device 210 on a circuit board). As best shown in FIG. 3B, the first terminal 226a may be in contact with the first contact portion 217a of the first high resistance layer 214a, and the second terminal 226b may be in contact with the second contact portion 217b of the second high resistance layer 214b.

During normal operation, the device 210 may be connected in a circuit between a source of electrical power and a load (e.g., via solder connection of the first and second terminals 226a, 226b to corresponding terminals on a circuit board), and current may flow through the device 210 from the first terminal 226a, to the first high resistive layer 214a, to the effective portion 218a of the PTC layer 218, to the second high resistive layer 214b, to the second terminal 226b, or vice versa.

Upon the occurrence of an overcurrent condition, wherein current flowing through the device 210 causes the PTC element 218 to reach a temperature within its normal trip temperature range, the resistance of the PTC element 218 may rapidly increase and substantially arrest current flowing therethrough, thus protecting connected circuit components from damage that could otherwise result from the overcurrent condition. Once the overcurrent condition subsides and the PTC element 218 cools to a temperature below its normal trip temperature range, the PTC element 218 may become electrically conductive again and the device 210 may resume normal operation.

Advantageously, the quantity of PTC material in the effective portion 218a of the PTC layer 218 of the device 210 is significantly less than the quantity of PTC material used in conventional PTC circuit protection devices of similar size. For example, the quantity of PTC material in the effective portion 218a may be in a range of 0.1 milligrams to 1 milligram, or about 10% or less of the quantity of PTC material used in conventional PTC circuit protection devices of similar size. Thus, the thermal mass of the effective portion 218a of the PTC layer 218 is greatly reduced relative to conventional PTC circuit protection devices, resulting in a significantly faster time to trip relative to conventional PTC circuit protection devices of similar size. For example, the device 210 may have a time to trip in a range of 10⁻¹ milliseconds to 10³ milliseconds. The present disclosure is not limited in this regard. Additionally, owing to the first and second high resistance layers 214a, 214b, the device 210 may exhibit relatively high electrical resistance, similar to conventional PTC circuit protection devices of similar size, even though the quantity of PTC material has been reduced. Moreover, the electrical resistance of the device 210 can be easily tailored/modified by changing the geometry (e.g., the width and/or thickness) of the first and second high resistance layers 214a, 214b. Still further, during an overcurrent condition in the device 210, the first and second high resistance layers 114a, 114b may act as heaters that expediate heating of the effective portion 218a of the PTC layer 218, further reducing the time to trip of the device 210.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A positive temperature coefficient (PTC) circuit protection device comprising:
a dielectric substrate layer;
first and second high resistance layers disposed on a top surface of the substrate layer in a spaced apart relationship to define a gap therebetween;
a PTC layer disposed on the top surface of the substrate layer, in the gap and in contact with the first and second high resistance layers;
a mask layer covering a top surface of the PTC layer and portions of top surfaces of the first and second high resistance layers;
an electrically conductive first terminal covering a first longitudinal end of the substrate layer and an outermost end of the first high resistance layer distal from the PTC layer; and
an electrically conductive second terminal covering a second longitudinal end of the substrate layer and an outermost end of the second high resistance layer distal from the PTC layer.

2. The PTC circuit protection device of claim 1, wherein the electrically conductive first terminal extends onto an exposed portion of the top surface of the first high resistance layer and wherein the electrically conductive second terminal extends onto an exposed portion of the top surface of the second high resistance layer.

3. The PTC circuit protection device of claim 1, wherein the PTC layer has a trip temperature in a range of 50 degrees Celsius to 220 degrees Celsius.

4. The PTC circuit protection device of claim 1, wherein a quantity of PTC material in the PTC layer is in a range of 0.1 milligrams to 1 milligram.

5. The PTC circuit protection device of claim 1, wherein the first and second high resistance layers are formed of a material having an electrical resistivity in a range of 10⁰ Ohm/to 10³ Ohm/.

6. The PTC circuit protection device of claim 1, wherein the first and second high resistance layers are metal foils formed of nickel-phosphorus plated with copper.

7. The PTC circuit protection device of claim 1, wherein the first and second high resistance layers are metal foils formed of nickel-chromium alloy.

8. The PTC circuit protection device of claim 1, wherein the mask layer is formed of epoxy.

9. A positive temperature coefficient (PTC) circuit protection device comprising:
a dielectric substrate layer;
a PTC layer disposed on the top surface of the substrate layer;
first and second high resistance layers disposed on a top surface of the PTC layer in a spaced apart relationship to define a gap therebetween, the PTC layer having an effective portion located directly below the gap;
a mask layer covering top surfaces of the first and second high resistance layers and covering the PTC layer in the gap;
an electrically conductive first terminal covering a first longitudinal end of the substrate layer and an outermost end of the first high resistance layer distal from the PTC layer; and
an electrically conductive second terminal covering a second longitudinal end of the substrate layer and an outermost end of the second high resistance layer distal from the PTC layer.

10. The PTC circuit protection device of claim 9, wherein the electrically conductive first terminal extends onto an exposed portion of the top surface of the first high resistance layer and wherein the electrically conductive second terminal extends onto an exposed portion of the top surface of the second high resistance layer.

11. The PTC circuit protection device of claim 9, wherein the PTC layer has a trip temperature in a range of 50 degrees Celsius to 220 degrees Celsius.

12. The PTC circuit protection device of claim 9, wherein a quantity of PTC material in the effective portion of the PTC layer is in a range of 0.1 milligrams to 1 milligram.

13. The PTC circuit protection device of claim 9, wherein the first and second high resistance layers are formed of a material having an electrical resistivity in a range of 10⁰ Ohm/to 10³ Ohm/.

14. The PTC circuit protection device of claim 9, wherein the first and second high resistance layers are metal foils formed of nickel-phosphorus plated with copper.

15. The PTC circuit protection device of claim 9, wherein the first and second high resistance layers are metal foils formed of nickel-chromium alloy.

16. The PTC circuit protection device of claim 9, wherein the PTC layer is formed of a polymeric PTC material.

17. A positive temperature coefficient (PTC) circuit protection device comprising:
a dielectric substrate layer having a first hole and a second hole formed therethrough;
first and second high resistance layers disposed on a top surface of the substrate layer in a spaced apart relationship to define a gap therebetween, wherein the first high resistance layer has a first contact portion extending into the first hole and the second high resistance layer has a second contact portion extending into the second hole;
a PTC layer disposed on the top of the first and second high resistance layers and having an effective portion extending into the gap;
a mask layer covering a top surface of the PTC layer;
an electrically conductive first terminal disposed on a bottom surface of the substrate layer and in contact with the first contact portion of the first high resistance layer; and
an electrically conductive second terminal disposed on the bottom surface of the substrate layer and in contact with the second contact portion of the second high resistance layer.

18. The PTC circuit protection device of claim 17, wherein the PTC layer has a trip temperature in a range of 50 degrees Celsius to 220 degrees Celsius.

19. The PTC circuit protection device of claim 17, wherein a quantity of PTC material in the effective portion of the PTC layer is in a range of 0.1 milligrams to 1 milligram.

20. The PTC circuit protection device of claim 17, wherein the first and second high resistance layers are formed of a material having an electrical resistivity in a range of 10⁰ Ohm/to 10³ Ohm/.
